(19) United States
(12) Patent Application Publication
(10) Pub. No.: US 2026/0291728 A1
(43) Pub. Date: Sep. 24, 2026

(54) CIPHERTEXT POLICY ATTRIBUTE BASED ENCRYPTION IN 5G CORE SERVICE BASED INTERFACE

(71) Applicant: SAMSUNG ELECTRONICS CO., LTD., Gyeonggi-do (KR)

(72) Inventors: Bharath Kumar RAVICHANDRAN, Bangalore (IN); Rajavelsamy RAJADURAI, Bangalore (IN); Aswin SASTHRI, Bangalore (IN); Ganesha ---, Bangalore (IN); Nivedya Parambath SASI, Bangalore (IN); Rohini RAJENDRAN, Bangalore (IN)

(21) Appl. No.: 19/168,115

(22) PCT Filed: Mar. 22, 2024
(86) PCT No.: PCT/KR2024/003629

§ 371 Date: Sep. 23, 2025

(30) Foreign Application Priority Data
Mar. 24, 2023 (IN) 202341021190
Mar. 11, 2024 (IN) 202341021190

(51) Int. Cl. H04L 9/08; H04L 9/06

(52) U.S. Cl. CPC H04L 9/0894; H04L 9/0618

(57) ABSTRACT

The disclosure relates to a 5G or 6G communication system for supporting a higher data transmission rate. Embodiments herein disclose a NRF entity for supporting a CP-ABE in 5GC SBI. The CP-ABE support controller stores a NF service producer profile and a NF service consumer profile. The CP-ABE support controller generates a master public key (505) and master secret key (503) using a key management server. The master public key is transmitted to the NF service producer entity based on the NF service producer profile. A secret key (511) is generated based on the set of attributes (507) and the master secret key (503), when the NF service consumer is authorized for the attribute criteria.

### TECHNICAL FIELD

The present invention relates to a wireless communication network, and more specifically related to providing granular access control in wireless communication networks, using ciphertext policy attribute based encryption (CP-ABE).

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mm Wave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/ protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission tech-nologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial In-telligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The principal object of the embodiments herein is to support a Ciphertext Policy Attribute Based Encryption (CP-ABE) in 5G Core (5GC) Service Based Interface (SBI).

Yet another object of the embodiments herein is to store a NF service producer profile of a plurality of NF service producer entities and a NF service consumer profile of a plurality of NF service consumer entities by a NRF entity.

Yet another object of the embodiments herein is to generate a master public key and master secret key using a key management server by the NRF entity.

Yet another object of the embodiments herein is to transmit the master public key to each NF service producer entity of the plurality of NF service producer entities.

Yet another object of the embodiments herein is to receive a secret key request message from the NF service consumer entity by the NRF entity.

Yet another object of the embodiments herein is to determine whether the NF service consumer entity is authorized based on an attribute criterion, wherein the attribute criteria comprises a set of attributes and their corresponding values.

Yet another object of the embodiments herein is to generate a secret key based on the set of attributes and their corresponding values and the master secret key, when the NF service consumer entity is authorized for the attribute criteria.

Yet another object of the embodiments herein is to transmit a secret key response message comprising the secret key to the NF service consumer entity.

Yet another object of the embodiments herein is to receive the master public key from an NRF by the NF service producer entity.

Yet another object of the embodiments herein is to receive a service access request message from the NF service consumer entity by the NF service producer entity.

Yet another object of the embodiments herein is to generate a service access response message by the NF service producer entity.

Yet another object of the embodiments herein is to encrypt the service access response message with an access policy using the master public key received from the NRF by the NF service producer entity.

Yet another object of the embodiments herein is to transmit the encrypted service access response message to the NF service consumer by the NF service producer entity.

Yet another object of the embodiments herein is to send a secret key request message to an NRF entity by a NF service consumer entity.

Yet another object of the embodiments herein is to receive a secret key response message comprising a secret key from the NRF by the NF service consumer entity.

Yet another object of the embodiments herein is to send a service access request message to the NF service producer entity by the NF service consumer entity.

Yet another object of the embodiments herein is to receive an encrypted service access response message from the NF service producer by the NF service consumer entity. The encrypted service access response message comprises an access policy based on which the encrypted service access response message is generated by the NF service producer entity.

Yet another object of the embodiments herein is to decrypt the encrypted service access response message using the secret key.

Yet another object of the embodiments herein is to determine whether the set of attributes and their corresponding values for the NF service consumer entity satisfies the access policy in the encrypted service access response message.

Yet another object of the embodiments herein is to decrypt the encrypted service access response message when the set of attributes and their corresponding values satisfies the access policy by the NF service consumer entity.

Yet another object of the embodiments herein is to send the encrypted service access response message in the NF service response message as the ciphertext over the access policy.

### Solution to Problem

Accordingly, an embodiment herein provides a NRF entity for supporting a CP-ABE in 5GC SBI. The NRF entity includes a memory configured to store information of NRF entity, a processor and a CP-ABE support controller, communicatively coupled to the memory and the processor. The CP-ABE support controller stores a NF service producer profile of a plurality of NF service producer entities and a NF service consumer profile of a plurality of NF service consumer entities. The CP-ABE support controller generates a master public key and master secret key using a key management server. The master public key is transmitted to each NF service producer entity of the plurality of NF service producer entities. The secret key request message is received from the NF service consumer entity. Further, the CP-ABE support controller determines whether the NF service consumer entity is authorized based on an attribute criterion, wherein the attribute criteria comprises a set of attributes and their corresponding values. A secret key is generated based on the set of attributes and the master secret key, when the NF service consumer entity is authorized for the attribute criteria. Finally, a secret key response message comprising the secret key is transmitted to the NF service consumer entity.

In an embodiment, the NRF entity stores the NF service consumer profiles. The NRF entity receives a client registration request message from the NF service consumer entity. Further, the NRF entity sends a client registration response message to the NF service consumer entity. The NRF entity stores the NF service consumer profile of the NF service consumer entity, upon successful registration of the NF service consumer entity.

In an embodiment, the set of attributes comprises a NF ID, a NF type, a service name, a type of operation, a slice ID, a PLMN ID, and a SNPN ID.

In an embodiment, the NF service producer entity is provided for supporting a CP-ABE in 5GC SBI. The NF service producer entity includes a memory configured to store information of the NRF entity, a processor and a CP-ABE support controller, communicatively coupled to the memory and the processor. The CP-ABE support controller receives a master public key from an NRF entity and a service access request message from a NF service consumer entity. Further, the CP-ABE support controller generates a service access response message. The service access response message is encrypted with an access policy using the master public key received from the NRF entity. Finally, the encrypted service access response message is transmitted to the NF service consumer entity.

In an embodiment, the access policy comprises at least one of a generic access policy and a restricted access policy.

In an embodiment, the generic access policy comprises a set of attributes. The set of attributes further comprises a NF ID, a NF type, a service name, a type of operation, a slice ID, a TPK ID, and a SNPN ID. Each of the attributes in the set of attributes can accept one or more values.

In an embodiment, the restricted access policy comprises a set of attributes. The set of attributes further comprises a NF ID, a NF type, a service name, a type of operation, a slice ID, a PLMN ID, and a SNPN ID. Each of the attributes in the set of attributes can accept only one value.

In an embodiment, the NF service consumer entity is provided for supporting a CP-ABE in 5GC SBI. The NF service producer entity includes a memory configured to store information of NRF entity, a processor and a CP-ABE support controller, communicatively coupled to the memory and the processor. The CP-ABE support controller sends a secret key request message to an NRF entity. The CP-ABE support controller receives a secret key response message comprising a secret key from the NRF entity. The secret key response message comprises an attribute criterion based on which the secret key is generated by the NRF entity. Further the CP-ABE support controller sends a service access request message to a NF service producer entity and receives an encrypted service access response message from the NF service producer entity. The encrypted service access response message comprises an access policy based on which the encrypted service access response message is generated by the NF service producer entity. Finally, the CP-ABE support controller decrypts the encrypted service access response message based on the attribute criteria and the access policy.

In an embodiment, the NF service consumer entity decrypts the encrypted service access response message based on the attribute criteria and the access policy. Further the NF service consumer entity, decrypts the encrypted service access response message when the attribute criteria of the NF service consumer entity satisfy the access policy of the NF service producer entity.

In an embodiment, the method includes supporting a CP-ABE in 5GC SBI. The method includes storing a NF service producer profile of a plurality of NF service producer entities and a NF service consumer profile of a plurality of NF service consumer entities, by the NRF entity. The method further generates the master public key and master secret key using the key management server. The NRF entity transmits the master public key to each NF service producer entity of the plurality of NF service producer entities. Further, the NRF entity receives a secret key request message from the NF service consumer entity. The NRF entity determines whether the NF service consumer entity is authorized based on an attribute criterion. The attribute criteria comprises a set of attributes and their corresponding values. Further, the NRF entity generates a secret key based on the set of attributes and the master secret key, when the NF service consumer entity is authorized for the attribute criteria. Finally, the NRF entity transmits the secret key response message comprising the secret key to the NF service consumer entity.

In an embodiment, the method includes supporting a CP-ABE in 5GC SBI. The method includes receiving the master public key from an NRF entity by the NF service producer entity. The NF service producer entity receives the service access request message from the NF service consumer entity and generates the service access response message. Further, the NF service producer entity encrypts the service access response message with an access policy using the master public key received from the NRF entity. Finally, the NF service producer entity transmits the encrypted service access response message to the NF service consumer entity.

In an embodiment, the method includes supporting a CP-ABE in 5GC SBI. The method includes sending the secret key request message to the NRF entity by the NF service consumer entity. The NF service consumer entity receives the secret key response message comprising the secret key from the NRF entity. The secret key response message comprises an attribute criterion based on which the secret key is generated by the NRF entity. Further, the NF service consumer entity sends a service access request message to the NF service producer entity. The NF service consumer entity receives an encrypted service access response message from the NF service producer entity. The encrypted service access response message comprises an access policy based on which the encrypted service access response message is generated by the NF service producer entity. Finally, the NF service consumer entity decrypts the encrypted service access response message based on the attribute criteria and the access policy.

### Advantageous Effects of Invention

According to an embodiment of present disclosure, a terminal can efficiently perform a communication.

### BRIEF DESCRIPTION OF DRAWINGS

This invention is illustrated in the accompanying drawings, throughout which like reference letters indicate corresponding parts in the various figures. The embodiments herein will be better understood from the following description with reference to the drawings, in which:

FIG. 1 illustrates a sequence diagram that illustrates the conventional flow of OAuth2.0 for direct inter NF communication, according to the embodiment disclosed herein;

FIG. 2 illustrates a block diagram illustrating various hardware components of the NRF entity for supporting a CP-ABE in 5GC SBI, according to the embodiment disclosed herein;

FIG. 3 illustrates a block diagram illustrating various hardware components of the NF service producer entity for supporting a CP-ABE in 5GC SBI, according to the embodiment disclosed herein;

FIG. 4 illustrates a block diagram illustrating various hardware components of the NF service consumer entity for supporting a CP-ABE in 5GC SBI, according to the embodiment disclosed herein;

FIG. 5 illustrates a block diagram that illustrates the general CP-ABE flow for encryption and decryption, according to the embodiment disclosed herein;

FIG. 6 illustrates a sequence diagram that illustrates the CP-ABE flow for direct inter NF communication in a SBA of 5G CN, according to the embodiment disclosed herein;

FIG. 7A illustrates sequence diagrams that illustrates an authentication procedure for NSWO in 5GS using CP-ABE, according to the embodiment disclosed herein;

FIG. 7B illustrates sequence diagrams that illustrates an authentication procedure for NSWO in 5GS using CP-ABE, according to the embodiment disclosed herein;

FIG. 7C illustrates sequence diagrams that illustrates an authentication procedure for NSWO in 5GS using CP-ABE, according to the embodiment disclosed herein;

FIG. 7D illustrates sequence diagrams that illustrates an authentication procedure for NSWO in 5GS using CP-ABE, according to the embodiment disclosed herein;

FIG. 8 illustrates a block diagram that illustrates the ABE system creating and distributing the secret keys to Third Party Service Providers (3SP), according to the embodiment disclosed herein;

FIG. 9 illustrates a schematic diagram that illustrates encryption/decryption of the contents in service operation messages that can be performed at the HTTP/2 or HTTP/3 layer, according to the embodiments as disclosed herein;

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help improve the understanding of aspects of the invention. Furthermore, the elements may have been represented in the drawing by conventional symbols, and the drawings may show only those specific details that are pertinent to the understanding of the embodiments of the invention so as not to obscure the drawing with details that will be readily apparent to those of ordinary skill in the art having the benefit of the description herein.

### Mode for the Invention

3^{rd} Generation Partnership Project (3GPP) specifies several mechanisms to protect the interaction between network function entities over the Service Based Interface (SBI). According to 3GPP TS 33.501, the key aspects specified are related to authentication and authorization involving the Network Repository Function (NRF), all Network Function(s) (NF) and other components such as Secure Connection Proxy (SCP), Security Edge Protection Proxy (SEPP), etc.

With respect to authentication, there are few approaches: Mutual Transport Layer Security (TLS), Network Domain Security (NDS), Physical Security or Client Credentials Assertion. The identities in the end entity certificates are used for authentication and policy checks. Network function entities can support both server side and client-side certificates.

Authorization is supposedly handled by either local policy or OAuth2.0, specifically the client credentials grant flow. There are several issues with the conventional implementation of OAuth 2.0 for Service Based Architecture in 5G Core Network specified in the 3GPP specification. The limitations of the specified mechanism are provided below.

According to the specification, Client Credentials Assertion (CCA) does not include the client_credential that is required for client authentication before an access token is issued by the authorization server. The Service Request process does not mention the CCA or the client_credential being sent in the access token request. Thus, without the client_credential, the NRF entity is not able to verify the authenticity of the client before issuing an access token.

Further, registration of fake NF Consumer/Producer entities to the NRF entity is possible. Except for the case of indirect communication via an SCP, the CCA is not included in any access token request from NF service consumer entity, but even then, there is no indication of client_credential being sent in the CCA. If only hop-by-hop security is used in a Public Land Mobile Network (PLMN), the NRF entity is not able to verify that an access token request sent by the SCP on behalf of a certain NF service consumer entity, is actually authorized by this consumer.

The CCA includes the X.509 URL (x5u) or the X.509 certificate chain (x5c) used for signing the client authentication assertion. This allows attackers to tamper the certificate URL or the attached certificate itself with a malicious one and generate a new signature in the absence of transport/network layer security. Further, relying on the public key in the message to verify itself is not ideal.

Unregistered NF consumer entities can request access tokens based on local authorization policy. Authentication (TLS) being decoupled from Authorization (OAuth2.0) allows masquerading attacks. Unlike OpenID Connect (OIDC), OAuth2.0 is merely an authorization framework and does not provide identity or authentication guarantee by itself. If the Public Land Mobile Network (PLMN) uses token-based authorization and the PLMN's policy mandates that the NRF authenticates the NF service consumer entity before granting an access token, the access token indicates to the NF service producer entity that the NF service consumer entity has been authenticated by the NRF entity. This allows for interception of the token, especially when the TLS is not enabled.

Further, DNS spoofing/poisoning is possible, which can redirect NRF/NF producer entity to malicious issuer URL that serves attacker controlled public key for signature verification which enables forging JSON web token (JWT) access tokens. Further the re-use of stolen authorization tokens is also possible.

The Remote Code Execution (RCE) vulnerabilities using reverse shells/deserialization attacks/out of bounds write can result in compromised NF entities thereby enabling additional attack vectors such as privilege escalation, DoS, data exfiltration and even deploying ransomware. This is especially concerning given the adoption of cloud-native practices and HTTP/2 based APIs in the 5GC Service Based Architecture (SBA).

Also, the attributes of NF entities which could not be included in the certificate that can be validated in an alternate way to ensure that malicious NF entities cannot impersonate them. The countermeasure to the issue is by providing decryption key during NF entity registration. The decryption key is derived based on the authorized attributes.

Hence, it is proposed to enhance the security for SBI by leveraging the CP-ABE to bind the authorization policy to the identity of the NF entity. Further, using the authorized attributes in the secret key derivation used for encryption and decryption of the information, thereby mitigating most of the aforementioned issues.

The embodiments herein and the various features and advantageous details thereof are explained more fully with reference to the non-limiting embodiments that are illustrated in the accompanying drawings and detailed in the following description. De-scriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments are described and illustrated in terms of blocks that carry out a described function or functions. These blocks, which are referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

The abbreviations used in the description:
5GC—5G Core
NRF—Network Repository Function
SCP—Secure Connection Proxy
SEPP—Security Edge Protection Proxy
TLS—Transport Layer Security
NF—network function
CCA—Client Credentials Assertion
JWT—JSON web token
MSK—Master Secret Key
MPK—Master Public Key
UDM—Unified Data Management
SMF—Session Management Function
PCF—Policy Control function
AUSF—Authentication Server Function
SNPN—Stand-alone Non-Public Network
KAF—Key Anchor Function
HTTP—Hypertext Transfer Protocol
DTLS—Datagram Transport Layer Security
QUIC—Quick UDP Internet Connections
TPK—Traffic Protection Key
PP—Platform Provider
AP—Access Point
NDS—Network Domain Security
SBI—Service Based Interface
SBA—Service Based Architecture
CP-ABE—Ciphertext-policy Attribute Based Encryption
PLMN—Public Land Mobile Network
UE—User Equipment
AMF—Access and Mobility Management Function
5G—Fifth Generation
3GPP—3rd Generation Partnership Project
NAS—Non-Access Stratum
RRC—Radio Resource Control
AF—Application Function
NSWOF—Non-Seamless WLAN Offload Function
KDS—Key Derivation Server
ABEA—Attribute Based Encryption Authority
3S P—Third Party Service Provider
HTTP—Hyper Text Transfer Protocol

Throughout the description the term “NRF entity” can also be “NRF” or “NRF device”.

Throughout the description the term “NF service producer entity” can also be “NF service producer” or “NF service producer device”.

Throughout the description the term “NF service consumer entity” can also be “NF service consumer” or “NF service consumer device”.

Throughout the description the term “attribute criteria” comprises the set of attributes and their corresponding values.

Throughout the description the term “access policy” comprises the authorized set of attributes and their corresponding values.

Throughout the description the term “setup (λ)” is a security parameter. The security parameter can be any random number that derives a master public key and a master secret key.

Embodiments disclosed herein provides a NRF entity for supporting a CP-ABE in 5GC SBI. The NRF entity includes a memory configured to store information of the NRF entity, a processor and a CP-ABE support controller, communicatively coupled to the memory and the processor. The CP-ABE support controller stores a NF service producer profile of a plurality of NF service producer entities and a NF service consumer profile of a plurality of NF service consumer entities. The CP-ABE support controller generates a master public key and a master secret key using a key management server. The master public key is transmitted to each NF service producer entity of the plurality of NF service producer entities. The secret key request message is received from the NF service consumer entity. Further, the CP-ABE support controller determines whether the NF service consumer is authorized based on an attribute criterion, wherein the attribute criteria comprises a set of attributes and their corresponding values. A secret key is generated based on the set of attributes and the master secret key, when the NF service consumer entity is authorized for the attribute criteria. Finally, a secret key response message comprising the secret key is transmitted to the NF service consumer entity for the target NF service producer entity.

Embodiments disclosed herein provide the NF service producer entity for supporting the CP-ABE in 5GC SBI. The NF service producer entity includes a memory configured to store information of the NRF entity, the processor and the CP-ABE support controller, communicatively coupled to the memory and the processor. The CP-ABE support controller receives the master public key from the NRF entity and the service access request message from the NF service consumer entity. Further, the CP-ABE support controller generates the service access response message. The service access response message is encrypted with the access policy using the master public key received from the NRF entity. Finally, the encrypted service access response message is transmitted to the NF service consumer entity.

Embodiments disclosed herein provide the NF service consumer entity for supporting the CP-ABE in 5GC SBI. The NF service producer entity includes a memory configured to store information of the NRF entity, the processor and the CP-ABE support controller, communicatively coupled to the memory and the processor. The CP-ABE support controller sends the secret key request message to the NRF entity. The CP-ABE support controller receives the secret key response message comprising the secret key from the NRF entity. The secret key response message comprises an attribute criterion based on which the secret key is generated by the NRF entity. Further the CP-ABE support controller sends the service access request message to the NF service producer entity and receives the encrypted service access response message from the NF service producer entity. The encrypted service access response message comprises the access policy based on which the encrypted service access response message is generated by the NF service producer entity. Finally, the CP-ABE support controller decrypts the encrypted service access response message based on the attribute criteria and the access policy.

Embodiments disclosed herein provide the method for supporting the CP-ABE in 5GC SBI. The method includes storing the NF service producer profile of a plurality of NF service producer entities and the NF service consumer profile of a plurality of NF service consumer entities, by the NRF entity. The method further generates the master public key and the master secret key using the key management server. The NRF entity transmits the master public key to each NF service producer entity of the plurality of NF service producer entities. Further, the NRF entity receives a secret key request message from the NF service consumer entity. The NRF entity determines whether the NF service consumer entity is authorized based on the attribute criterion. The attribute criteria comprises the set of attributes and their corresponding values. Further, the NRF entity generates the secret key based on the set of attributes and the master secret key, when the NF service consumer entity is authorized for the attribute criteria. Finally, the NRF entity transmits the secret key response message comprising the secret key to the NF service consumer entity for the target NF service producer entity.

Embodiments disclosed herein provide the method for supporting a CP-ABE in 5GC SBI. The method includes receiving the master public key from the NRF entity by the NF service producer entity. The NF service producer entity receives the service access request message from the NF service consumer entity and generates a service access response message. Further, the NF service producer entity encrypts the service access response message with the access policy using the master public key received from the NRF entity. Finally, the NF service producer entity transmits the encrypted service access response message to the NF service consumer entity.

Embodiments disclosed herein provide the method for supporting a CP-ABE in 5GC SBI. The method includes sending the secret key request message to the NRF entity by the NF service consumer entity. The NF service consumer entity receives the secret key response message comprising the secret key from the NRF entity. The secret key response message comprises an attribute criterion based on which the secret key is generated by the NRF entity. Further, the NF service consumer entity sends the service access request message to the NF service producer entity. The NF service consumer entity receives the encrypted service access response message from the NF service producer entity. The encrypted service access response message comprises an access policy based on which the encrypted service access response message is generated by the NF service producer entity. Finally, the NF service consumer entity decrypts the encrypted service access response message based on the attribute criteria and the access policy.

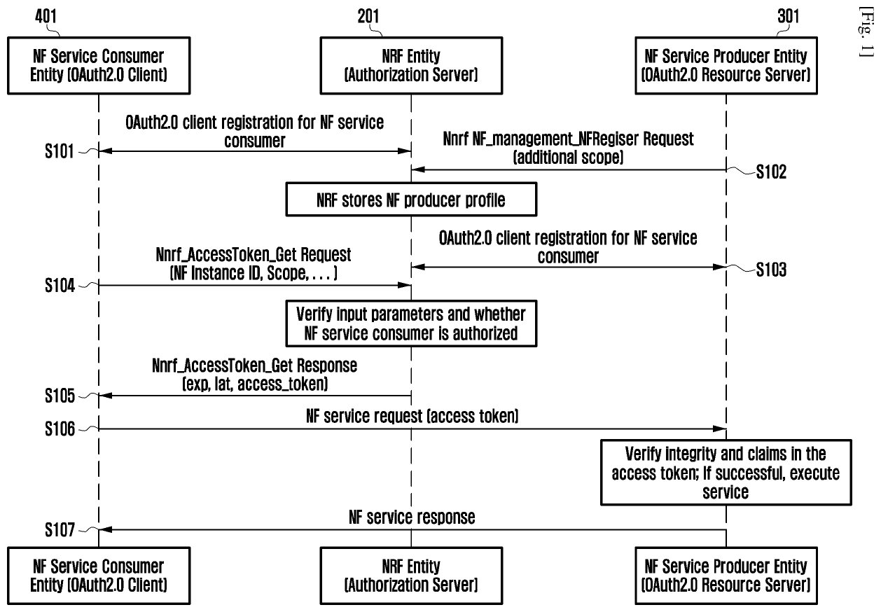

FIG. 1 is a sequence diagram that illustrates the conventional flow of OAuth2.0 for direct inter NF communication, according to the embodiment disclosed herein. FIG. 1 includes the NRF entity (Authorization server) (201), NF service producer entity (OAuth2.0 resource server) (301), and NF service consumer entity (OAuth2.0 client) (401).

At step S101, OAuth2.0 client registration for NF service consumer entity is performed.

At step S102, the NF service producer entity (301) requests the NRF entity (201) for the registration through “Nnrf NF_management_NFRegiser Request”. The NRF entity (201) based on the request stores the NF producer profile.

At step S103, the OAuth2.0 client registration for the NF service consumer entity (401) is performed.

At step S104, the NF service consumer entity (401) requests the NRF entity (201) for access token through “Nnrf_AccessToken_Get Request”. The NRF entity (201) verifies the input parameters and whether the NF service consumer entity (401) is authorized based on the received request.

At step S105, the NRF entity (201) provides the response to the NF service consumer entity (401) through “Nnrf_AccessToken_Get Response”.

At step S106, the NF service consumer entity (401) sends a service request to the NF service producer entity (301) along with the access token. The NF service producer entity (301) verifies the integrity and claims in the access token and if successful, executes the service.

At step S107, the NF service producer entity (301) provides the response to the NF service consumer entity (401) service request.

There are several issues with the implementation of OAuth2.0 for SBA in 5GC Network specified in the 3GPP specification. The CCA does not include the client_credential that is required for client authentication before an access token is issued by the authorization server. The Service Request Process does not mention the CCA or the client_credential being sent in the access token request. Without a client_credential, the NRF is not able to verify the authenticity of the client before issuing an access token. Further, registration of fake NF Consumer/Producer entity to the NRF entity is possible. Except for the case of indirect communication via an SCP, the CCA is not included in any access token request from the NF service consumer entity, but even then, there is no indication of client_credential being sent in the CCA. If only hop-by-hop security is used in a PLMN, the NRF is NOT able to verify that an access token request sent by SCP on behalf of a certain NF service consumer, is actually authorized by this consumer. The CCA includes the X.509 URL (x5u) or the X.509 certificate Chain (x5c) used for signing the client authentication assertion. This allows attackers to tamper the certificate URL or the attached certificate itself with a malicious one and generate a new signature in the absence of transport/network layer security. Further, relying on the public key in the message to verify itself is not ideal.

Unregistered NF consumers CAN request access tokens based on local authorization policy. When the authentication (TLS) is decoupled from the authorization (OAuth2.0), it allows masquerading attacks. Unlike OpenID Connect (OIDC), OAuth2.0 is merely an authorization framework and does not provide identity or authentication guarantee by itself. The specification defines that if the PLMN uses token-based authorization and the PLMN's policy mandates that the NRF authenticates the NF service consumer before granting an access token, the access token indicates to the NF service producer entity that the NF service consumer entity has been authenticated by the NRF entity. This allows for interception of the token, especially when TLS is not enabled. Further, DNS spoofing/poisoning is possible, which can redirect NRF/NF Producer to malicious issuer URL that serves attacker controlled public key for signature verification which enables forging JWT access tokens. Further the re-use of stolen authorization tokens is also possible. Remote Code Execution (RCE) vulnerabilities using reverse shells/deserialization attacks/out of bounds write can result in compromised NFs thereby enabling additional attack vectors such as privilege escalation, DoS, data exfiltration and even deploying ransomware. This is especially concerning given the adoption of cloud-native practices and HTTP/2 based APIs in the 5GC Service Based Architecture (SBA). Also, the attributes of NFs which could not be included in the certificate that can be validated in an alternate way to ensure that malicious NFs cannot impersonate them. Countermeasure to the issue is by providing decryption key during NF registration. The decryption key is derived based on the authorized attributes.

Hence, it is proposed to enhance the security for SBI by leveraging the CP-ABE to bind the authorization policy to the identity of the NF and using the authorized attributes in the secret key derivation that to be used for encryption and decryption of the information, thereby mitigating most of the aforementioned issues.

The proposed technical solution boasts inventive features that involve the implementation of CP-ABE to protect the authenticity and integrity of interactions between network functions over the SBI and provide granular access control for those interactions. The NRF entity also aims to provide means to enforce granular access control over a set of symmetric or asymmetric cryptographic keys which provide the protection by using the CP-ABE.

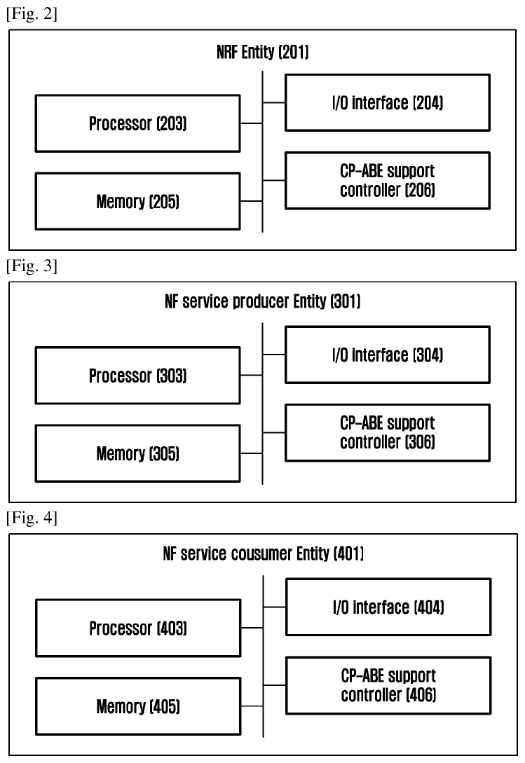

Embodiments herein achieve entity and a method for supporting the CP-ABE in 5GC SBI. Referring now to the drawings, and more particularly to FIGS. 2 through 9, where similar reference characters denote corresponding features consistently throughout the figures, there are shown embodiments.

FIG. 2 is a block diagram illustrating various hardware components of the NRF entity (201) for supporting the CP-ABE in 5GC SBI, according to the embodiment disclosed herein.

The NRF entity (201) may include a processor (203), am I/O interface (204), a memory (205) configured to store information of NRF entity, a processor and the CP-ABE support controller, communicatively coupled to the memory and the processor.

Further, the memory (205) of the NRF entity (201), NF service producer entity (301) and the NF service consumer entity (401) includes storage locations to be addressable through the processor (203). The memory (205) is not limited to a volatile memory and/or a non-volatile memory. Further, the memory (205) may include one or more computer-readable storage media. The memory (205) may include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory (205) stores the NF service producer profile of a plurality of NF service producer entities and a NF service consumer profile of a plurality of NF service consumer entities. The memory also stores the registration request data, service request data and attributes, access policies, messages. The memory stores the data transferred between the different NFs of the 5GC network.

The processor (203) is configured to execute instructions stored in the memory (205) and to perform various processes. The processor (203) may include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The I/O Interface (204) transmits the information between the memory (205) and external peripheral entities. The external peripheral entities are the input-output entities associated with the NRF entity (201), the NF service producer entity (301) and the NF service consumer entity (401). The I/O interface (204) receives a secret key request message from the NF service consumer entity. The I/O interface (204) transmits a secret key response message comprising the secret key to the NF service consumer for the target NF service producer entity for the NRF entity (201).

The CP-ABE support controller (206) is an innovative hardware that is realized through the physical implementation of both analog and digital circuits, including logic gates, integrated circuits, microprocessors, microcontrollers, memory circuits, passive and active electronic components, as well as optical components.

The CP-ABE support controller (206) stores the NF service producer profile of a plurality of NF service producer entities and a NF service consumer profile of the plurality of NF service consumer entities. The CP-ABE support controller generates the master public key and master secret key using a key management server. The master public key is transmitted to each NF service producer entity of the plurality of NF service producer entities. The secret key request message is received from the NF service consumer entity. Further, the CP-ABE support controller determines whether the NF service consumer entity is authorized based on the attribute criterion, wherein the attribute criteria comprises a set of attributes and their corresponding values. A secret key is generated based on the set of attributes and the master secret key, when the NF service consumer entity is authorized for the attribute criteria. Finally, the secret key response message comprising the secret key is transmitted to the NF service consumer entity for the target NF service producer entity.

In an embodiment, the NRF entity stores the NF service consumer profiles. The NRF entity receives a client registration request message from the NF service consumer entity. Further, the NRF entity sends the client registration request message to the NF service consumer entity. The NRF entity stores the NF service consumer profile of the NF service consumer entity, upon successful registration of the NF service consumer entity.

In an embodiment, the set of attributes comprises at least one of a NF ID, a NF type, a service name, a type of operation, a slice ID, a PLMN ID, or a SNPN ID.

FIG. 3 is a block diagram illustrating various hardware components of the NF service producer entity for supporting a CP-ABE in 5GC SBI, according to the embodiment disclosed herein. The NF service producer entity (301) may include a processor (303), an I/O interface (304), a memory (305) configured to store information of NRF entity, a processor and the CP-ABE support controller (306), communicatively coupled to the memory and the processor.

The Further, the memory (305) of NF service producer entity (301) may include storage locations to be addressable through the processor (303). The memory (305) is not limited to a volatile memory and/or a non-volatile memory. Further, the memory (305) may include one or more computer-readable storage media. The memory (305) may include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory may store the received master public key from the NRF entity. The memory may also store the received service access request message from the NF service consumer entity.

The processor (303) is configured to execute instructions stored in the memory (305) and to perform various processes. The processor (303) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The I/O Interface (304) transmits the information between the memory (305) and external peripheral entities. The external peripheral entities are the input-output entities associated with the NF service producer entity (301). The I/O interface (304) receives the master public key from the NRF entity and transmits the encrypted service access response message to the NF service consumer entity for the NF service producer entity (301).

The CP-ABE support controller (306) is an innovative hardware that is realized through the physical implementation of both analog and digital circuits, including logic gates, integrated circuits, microprocessors, microcontrollers, memory circuits, passive and active electronic components, as well as optical components.

The CP-ABE support controller (306) receives the master public key from the NRF entity and the service access request message from the NF service consumer entity. Further, the CP-ABE support controller (306) generates the service access response message. The service access response message is encrypted with the access policy using the master public key received from the NRF entity. Finally, the encrypted service access response message is transmitted to the NF service consumer entity.

In an embodiment, the encrypted service access response message is sent in the NF service response message as the ciphertext over the access policy.

In an embodiment, the access policy comprises at least one of a generic access policy and a restricted access policy.

In an embodiment, the generic access policy comprises a set of attributes. The set of attributes further comprises at least one of a NF ID, a NF type, a service name, a type of operation, a slice ID, a PLMN ID, or a SNPN ID. Each of the attributes in the set of attributes can accept one or more values.

In an embodiment, the restricted access policy comprises a set of attributes. The set of attributes further comprises at least one of a NF ID, a NF type, a service name, a type of operation, a slice ID, a PLMN ID, or a SNPN ID. Each of the attributes in the set of attributes can accept only one value.

FIG. 4 is a block diagram illustrating various hardware components of the NF service consumer entity for supporting the CP-ABE in 5GC SBI, according to the embodiment disclosed herein. The NF service consumer entity (401) may include a processor (403), an I/O interface (404), a memory (405) configured to store information of NRF entity, a processor and the CP-ABE support controller (406), communicatively coupled to the memory and the processor.

The Further, the memory (405) of NF service consumer entity (401) may include storage locations to be addressable through the processor (403). The memory (405) is not limited to a volatile memory and/or a non-volatile memory. Further, the memory (405) may include one or more computer-readable storage media. The memory (405) may include non-volatile storage elements. For example, non-volatile storage elements may include magnetic hard discs, optical discs, floppy discs, flash memories, or forms of electrically programmable memories (EPROM) or electrically erasable and programmable (EEPROM) memories. The memory may store the received secret key response message comprising the secret key from the NRF entity. The memory may also store the received encrypted service access response message from the NF service producer entity.

The processor (403) is configured to execute instructions stored in the memory (405) and to perform various processes. The processor (403) may include one or a plurality of processors, may be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The I/O Interface (404) transmits the information between the memory (405) and external peripheral entities. The external peripheral entities are the input-output entities associated with the NF service consumer entity (401). The I/O interface (404) receives the secret key response message comprising the secret key from the NRF entity and sends the service access request message to the NF service producer entity for the NF service consumer entity (401).

The CP-ABE support controller (406) is an innovative hardware that is realized through the physical implementation of both analog and digital circuits, including logic gates, integrated circuits, microprocessors, microcontrollers, memory circuits, passive and active electronic components, as well as optical components.

The CP-ABE support controller (406) sends the secret key request message to the NRF entity. The CP-ABE support controller (406) receives the secret key response message comprising a secret key from the NRF entity. The secret key response message comprises an attribute criterion based on which the secret key is generated by the NRF entity. Further the CP-ABE support controller sends a service access request message to the NF service producer entity and receives an encrypted service access response message from the NF service producer entity. The encrypted service access response message comprises the access policy based on which the encrypted service access response message is generated by the NF service producer entity. Finally, the CP-ABE support controller decrypts the encrypted service access response message based on the attribute criteria and the access policy.

In an embodiment, the NF service consumer entity decrypts the encrypted service access response message based on the attribute criteria and the access policy. Further the NF service consumer entity, decrypts the encrypted service access response message when the attribute criteria of the NF service consumer entity satisfy the access policy of the NF service producer entity.

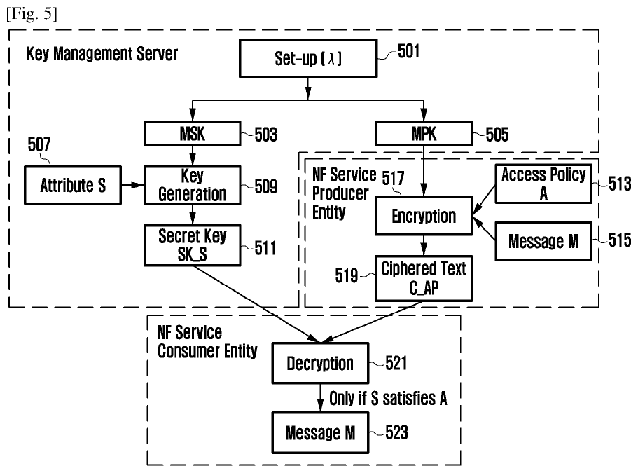

FIG. 5 is a block diagram that illustrates the general CP-ABE flow for encryption and decryption, according to the embodiment disclosed herein. The CP-ABE associates secret keys with attributes and ciphertexts with access policies. The messages to be encrypted can be of arbitrary integer length.

The setup (λ) block (501) specifies a security parameter (λ) and outputs system parameters (PARAMS_CP-ABE), a master public key (MPK_CP-ABE) (505), and a master secret key (MSK_CP-ABE) (503).

The secret key generation block (509) takes the master secret key (MSK_CP-ABE) (503), and an attribute set A (509) as input, and output a secret key (SK_S) (511).

The encryption block (517) takes the master public key (MPK_CP-ABE), a message M, an access policy A, and a random tape R as input and outputs a ciphertext (C_AP) (519). The access policy is extractable from ciphertext (C_AP) (519). The random tape R is a uniformly random bitstring from {0,1}k.

The decryption block (521) takes a secret key (SK_S) (511) associated with an attribute S (507), and a ciphertext (C_AP) (519) associated with the access policy A as input, and outputs a message M (523). The message M (523) is generated when the attribute S (507) satisfy the access policy A (513). When the attribute S (507) do not satisfy the access policy A (513) an error is generated indicating that the decryption is failed.

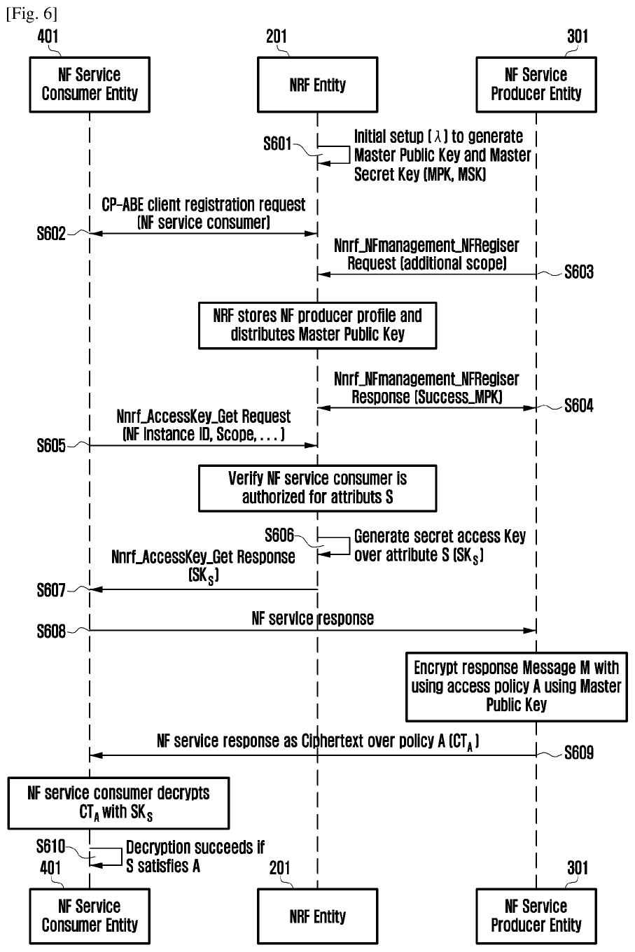

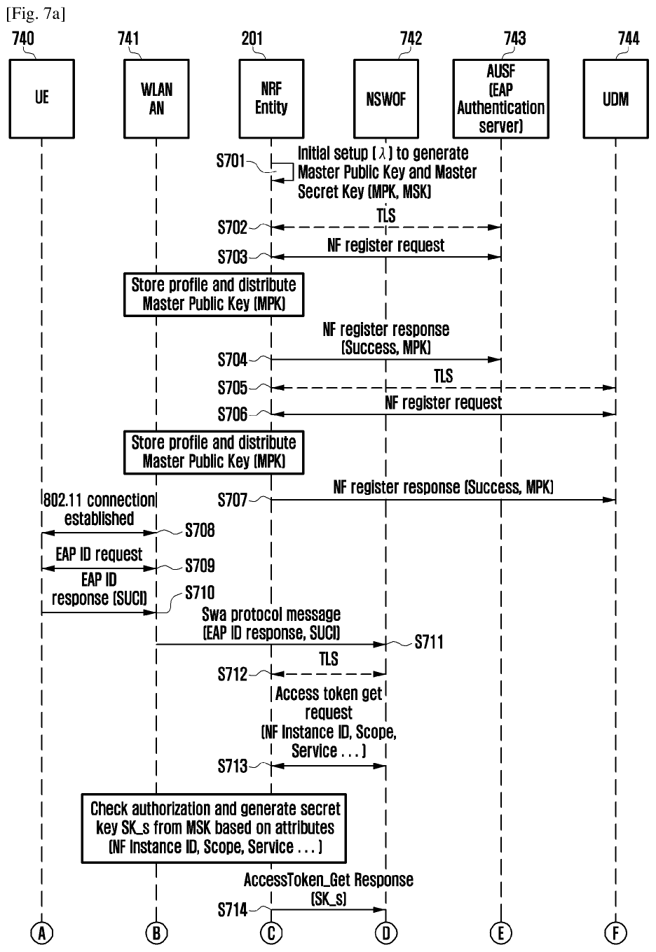

FIG. 6 is a sequence diagram that illustrates the CP-ABE flow for direct inter NF communication in a SBA of 5G CN, according to the embodiment disclosed herein.

At step S601, the setup (λ) at NRF entity (101) may generate the Master Public Key and the Master Secret Key.

At step S602, the client registration for NF service consumer entity is performed.

At step S603, the NF service producer entity (301) may request the NRF entity (201) for the registration through “Nnrf NF_management_NFRegiser Request”.

At step S604, NRF entity (201) may store the NF producer profile and distributes the Master Public Key to the NF service producer (Nnrf_NFManagement_NFRegister response, MPK).

At step S605, the NF service consumer entity (401) may request the secret key to the NRF entity (201) for the target NF service producer entity (Nnrf_AccessKey_Get Request) (NF Instance id, scope, . . . ). The NRF entity verifies if the NF service consumer entity is authorized for attribute S.

In an embodiment, the NRF entity (201) may verify whether the NF service consumer entity is authorized for the attribute S against locally configured policy/database or verifies using an external entity for example Operations, Administration, and Maintenance (OAM) server.

At step S606, the NRF entity (201) then may generate a secret key over authorized/ allowed attribute S (SK_S).

In an embodiment, the attributes comprise at least one of a NF ID, a NF type, a service name, a type of operation, a slice ID, a PLMN ID, or a SNPN ID. Further, the example of the NF type attribute comprises AMF, SMF, PCF, Unified Data Management (UDM), AAnF, Authentication Server Function (AUSF), Non-Seamless WLAN Offload Function (NSWOF), etc. The example of the service name attribute comprises UDM Services (Nudm_SubscriberDataManagement (SDM) Service, Nudm_SDM_Get service operation, Nudm_SDM_Subscribe service operation etc. The example of the type of operation attribute comprises create, modify, read, write, put etc. Further, the examples of additional attributes comprise at least one of S-NSSAIs, PLMNs, or SNPNs.

In an illustrative example, the attribute S may be one or more of AMF, Nudm_SDM_Get service operation, read, Slice ID (NSSAI), PLMN ID.

In another illustrative example, the attribute S may be one or more of SMF, Nudm_SDM_Subscribe service operation, read, PLMN ID.

In another illustrative example, the attribute S may be one or more of Nudm_UEAuthentication_Get service operation, PLMN ID, AUSF, read.

In another illustrative example, the attribute S may be one or more of Nausf_UEAuthentication_Authenticate Request service operation, AccessNetwork Identity, SWO_indicator, POST.

In another illustrative example, the attribute S may be one or more of read, PLMN ID, AUSF, Nudm_UEAuthentication_ResultConfirmation service operation.

At step S607, the NRF entity (201) may provide the response to the NF service consumer entity (401) through “Nnrf_AccessKey_Get Response”.

At step S608, the NF service consumer entity (401) may provide the response to the NF service producer entity (301) for NF service. The NF service producer entity (201) may encrypt the response message M with access policy A using the Master Public Key.

In an embodiment, the sequence of attributes to be followed for example, Attribute={NF ID, NF Type, Service Name, Type of operation, Slice ID, PLMN ID, SNPN ID}.

In an embodiment, a key anchor (or derivation function or server) (Key Anchor Function (KAF)/ Key Derivation Server (KDS)) may derive the security parameter λ, the master secret key and the master public key and provides it to the NRF entity. The NRF entity may generate and provides the secret key (SK_S) to the NF entity.

In an embodiment, a key anchor (or derivation function or server) (KAF/KDS) derives the security parameter (λ), the master secret key, the master public key, the secret key and provides the master public key, the secret key to the NRF entity. The NRF entity may provide the secret key to the NF entity.

In an embodiment, the KAF/KDS is co-located with the NRF entity or can be a separate network function.

In an embodiment, the KAF/KDS may derive the security parameter (λ), the master secret key, the master public key, the secret key and provides the master public key to the NRF entity and provides the secret key to the NF entity. The KAF/KDS may provide the secret key (SK_S) directly to the NF entity, when the NF entity requests the KAF/KDS to provide the key and provides the master public key to the NRF entity directly when the NF entity requests the KAF/KDS to provide the key.

In an embodiment, the access policy may comprise at least one of a generic access policy and a restricted access policy.

In an embodiment, the generic access policy may comprise a set of attributes, wherein the set of attributes comprises a NF ID, a NF type, a service name, a type of operation, a slice ID, a PLMN ID, and a SNPN ID.

In an embodiment, each of the attributes in the set of attributes can accept one or more values.

The examples of the generic access policy comprise one or more of:
AMF or SMF, READ or WRITE, NSSAI-1 or NSSAI-2, Get_SDM
NF ID1 or NF ID2 or NF ID5, READ or WRITE, NSSAI-1 or NSSAI-2, Get_SDM, Any PLMN ID (wildcard)
Any NF ID (wildcard), READ or WRITE, NSSAI-1 or NSSAI-2, Get_SDM, Any PLMN ID (wildcard)

In an embodiment, the restricted access policy comprises a set of attributes, wherein the set of attributes comprises at least one of a NF ID, a NF type, a service name, a type of operation, a slice ID, a PLMN ID, or a SNPN ID.

In an embodiment, each of the attributes in the set of attributes can accept only one value.

The examples of the restricted access policy comprise one or more of:
SMF, READ, NSSAI-1, Get_SDM
AMF, READ or WRITE, NSSAI-2, Get_SDM
NF ID1, UDM, READ or WRITE, NSSAI-3, Nausf_UEAuthentication_Authenticate service operation, PLMN ID1

In an embodiment, to have uniqueness of secret key per NF entity, the attribute set may include the NF Identity (ID). Inclusion of the NF ID in the Secret key generation ensures the generated key is unique for that NF entity. In case if the secret key generation includes the NF ID in attribute set, then access policy also needs to include the authorized list of NF IDs to those to decrypt the received encrypted message. In an embodiment, the NF producer entity may include all the allowed NF consumer entities NF ID in the access policy. In an embodiment, the NF producer entity may include a wildcard attribute for the NF consumer ID, which means there is no access control from NF ID perspective.

In an embodiment, for example, if the secret key is being in use for long-time (say more than a year) or it is being identified that the issued key may be compromised, then it is required to refresh the issued secret key. In order to have a fresh key for every derivation, freshness parameter is included in the Secret key generation. In case, if the secret-key generation includes the freshness parameter in attribute set, then access policy also needs to include the freshness parameter to decrypt the received encrypted message. In an embodiment, the freshness parameter being year (for example, Y2023) which means the issued key is valid for the year 2023.

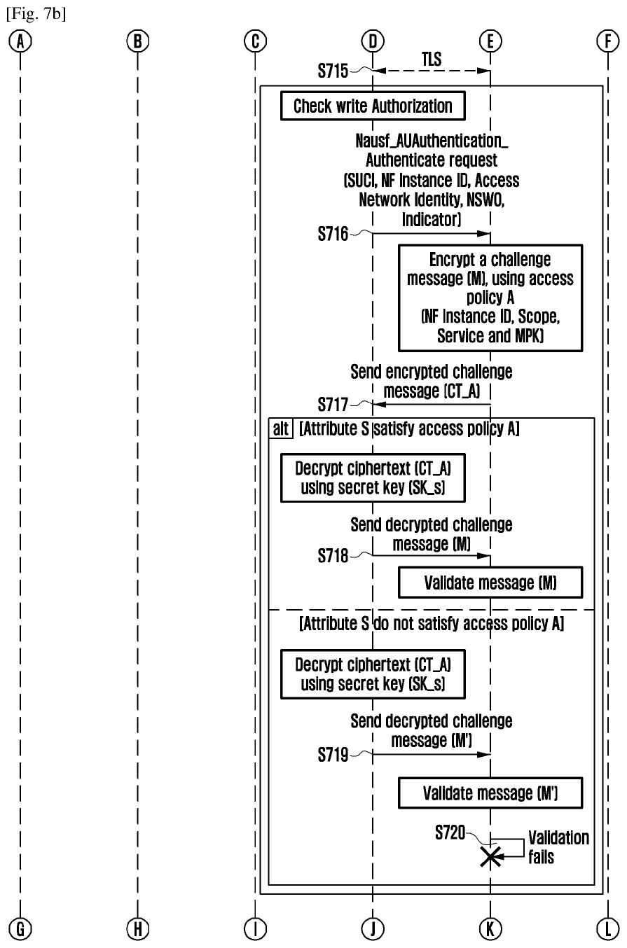

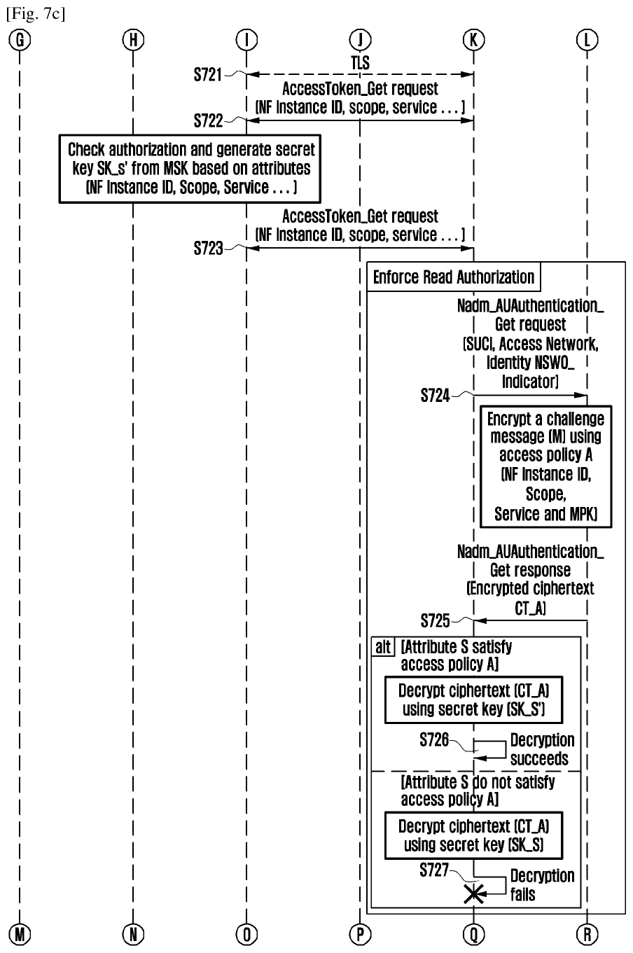

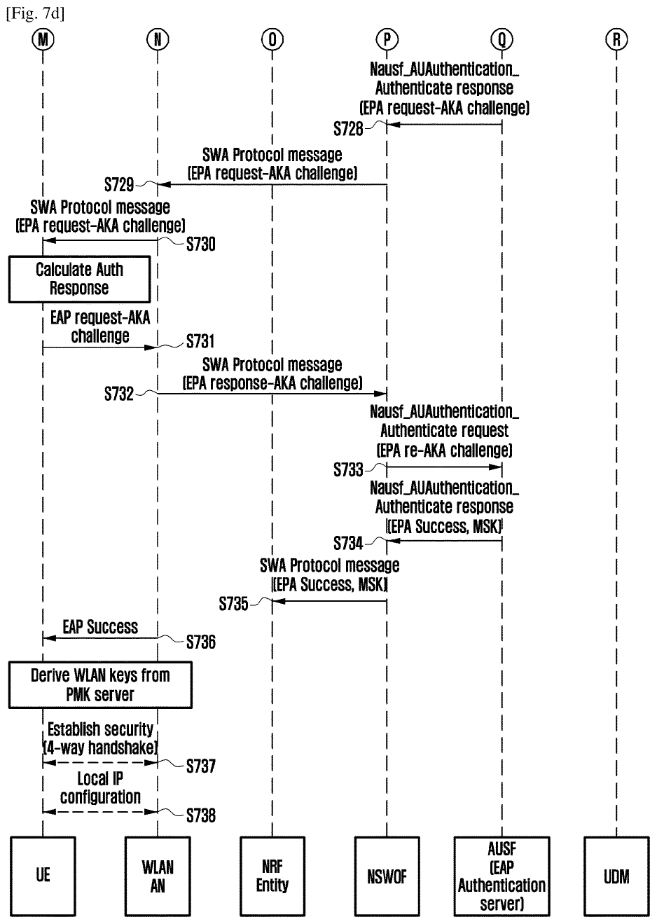

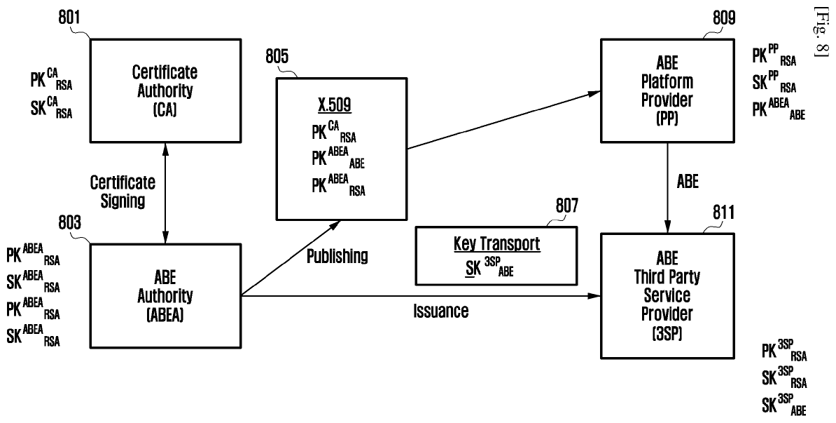

FIGS. 7A-7D are sequence diagrams that illustrates an authentication procedure for Non-Seamless WLAN Offload Function (NSWO) in 5GS using CP-ABE, according to the embodiment disclosed herein. The generation, distribution and revocation of the secret keys can be implemented parallel to the TLS keys and certificates in authentication procedure for NSWO in 5GS using CP-ABE.

This may be extended to other use cases such as indirect NF communication involving the SCP. The flow for authentication procedure for NSWO in 5GS using CP-ABE in FIG. 7A is as follows:

At step S701, the NRF entity may initiate the initial setup to generate the Master Public Key and the Master Secret Key.

At step S702, the Authentication Server Function (AUSF) (743) may perform initial TLS establishment procedure and establishes TLS between the NRF entity and the AUSF (43).

At step S703, upon successful establishment of the TLS, the NRF entity may receive the NF Registration Request from the AUSF (743). Then the NRF may store the profile of the AUSF and distributes the Master Public Key to the AUSF (743).

At step S704, the NRF entity may provide the NF register response to the AUSF (743) indicating success.

At step S705, the Unified Data Management (UDM) function may perform initial TLS establishment procedure and establishes TLS between the NRF entity and the UDM.

At step S706, upon successful establishment of the TLS, the NRF entity may receive the NF Registration Request from the UDM. Then the NRF may store the profile of the AUSF (743) and distributes the Master Public Key to the UDM (744).

At step S707, the NRF entity may provide the NF register response to the UDM (744) indicating success.

At step S708, the User Equipment (UE) may establish the connection with the WLAN (741), according to IEEE 802.11 specifications.

At step S709, the WLAN (741) may request the UE (740) to provide an EAP-ID.

At step S710, the EAP-ID response (SUCI) in sent to the WLAN (741) by UE (740).

At step S711, the WLAN (741) may send SWA protocol message which contains the EAP-ID and the SUCI to NSWOF (742) to initiate the authentication of the UE (740). In order to access the AUSF (743), the NSWOF (742) may request the access rights from the NRF entity.

At step S712, the NSWOF (742) may establish a TLS connection with the NRF entity.

At step S713, the NSWOF (742) then may request the shared secret key from the NRF entity, by sending a request message. Upon receiving the request message, the NRF entity may verify whether NSWOF (742) is authorized for the AUSF (743) access and also the granularity of the access of the service provided by the AUSF. Based on the authorized access attributes, the NRF entity may generate secret key (SK_S) from Master Secret Key based on attributes S such as NF instance ID, Scope, service, etc. for the NSWOF (742).

At step S714, the NRF entity may provide the generated secret key (SK_S) to the NSWOF (742) in a response message.

The NF service producer entity may validate the authorization of the NF service consumer entity before executing a “request to modify data” through the service procedure (e.g., create, update, delete). The NF service producer entity encrypts a challenge message using the relevant access policy (A) and the master public key. This encrypted message may be sent to the NF service consumer entity. The NF service consumer entity, possessing the corresponding secret key SK_S, decrypts the challenge message and returns the response to the NF service producer entity. The NF service producer entity may validate the authorization based on the received response and proceeds to execute the request to modify the data. If the challenge message is invalid, indicating failed authorization, the NF service producer entity rejects the request.

The flow for authentication procedure for NSWO in 5GS using CP-ABE in FIG. 7B is as follows:

At step S715, upon receiving the secret key (SK_S), the NSWOF (742) establishes the TLS connection with the AUSF (743).

At step S716, the NSWOF (742) may send Nausf_UEAuthentication service request message to the AUSF (743). On receiving the request, the AUSF challenges the AUSF as to verify the granularity of the access. The AUSF (743) may take the master public key, challenge message M, an access policy A, and other possible parameters as input and outputs a ciphertext challenge message.

At step S717, the AUSF (743) then may send the encrypted message to the NSWOF (742) to response to the challenge.

At step S718, the NSWOF (742) may decrypt the challenge based on the secret key received from the NRF entity. The decrypted challenge is validated successfully by the AUSF (743) when the attribute S satisfies the access policy A.

At step S719, the NSWOF (742) may send the decrypted challenge message to the AUSF. Then the AUSF may verify whether the challenge response is correct. The decrypted challenge is validated by the AUSF and error occurs when the attribute S do not satisfy the access policy A.

At step S720, if the response to the challenge from the NSWOF (742) is incorrect, then the AUSF stops further procedure and terminates the session.

To enforce granular access control for the request to share data through the service procedure (for example, get, read), the NF service producer entity sends a response message encrypted using the relevant access policy (A) and the master public key. The NF service consumer entity, possessing the corresponding secret key (SK_S), decrypts the response message. The decryption fails if the NF service consumer entity lacks the appropriate secret key.

The flow for authentication procedure for NSWO in 5GS using CP-ABE in FIG. 7C is as follows:

At step S721, the AUSF may establish the TLS connection with the NRF entity.

At step S722, the AUSF then may request the shared secret key from the NRF entity, by sending a request message. Upon receiving the request message, the NRF entity may verify whether the AUSF is authorized for the AUSF access and also the granularity of the access of the service provided by the UDM (744). Based on the authorized access attributes, the NRF entity generates secret key (SK_S') from Master Secret Key based on attributes S' such as NF instance ID, Scope, service, etc. for the AUSF.

At step S723, the NRF entity may provide the generated secret key (SK_S') to the AUSF in the response message. Upon receiving the secret key (SK_S'), the AUSF establishes the TLS connection with the UDM (744) and sends Nudm_UEAuthentication Get service request message to the UDM.

At step S724, the AUSF may send Nudm_AUAuthentication_Get request message to the UDM (744). On receiving the request, the UDM challenges the AUSF as to verify the granularity of the access. The UDM (744) may take the master public key, challenge message M, an access policy A, and other possible parameters as input and output a ciphertext challenge message (CT_A).

At step S725, the UDM (744) may send the encrypted message to the AUSF as part of the Nudm_UEAuthentication Get Response.

At step S726, the AUSF may decrypt the challenge based on the secret key received from the UDM (744). The decrypted challenge is validated successfully by the AUSF when the attribute S satisfies the access policy A.

At step S727, the decrypted challenge is validated by the AUSF and error occurs when the attribute S do not satisfy the access policy A. If the decryption fails, then the AUSF stops the further procedures and terminates the session.

The flow for authentication procedure for NSWO in 5GS using CP-ABE in FIG. 7D is as follows: The steps 728-736 provides the sequence of EAP exchange between the network and the UE.

At step S728, the Nausf_AUAuthentication_Authenticate response may be sent from the AUSF to NSWOF (742).

At step S729, the SWA Protocol message may be sent from the NSWOF (742) to WLAN (741).

At step S730, the SWA Protocol message may be sent from the WLAN (741) to the UE (740). The UE (740) then may calculate the authentication response.

At step S731, the EAP request may be sent from the UE (740) to the WLAN (741).

At step S732, the SWA Protocol message may be sent from the WLAN (741) to NSWOF (742).

At step S733, the Nausf_AUAuthentication_Authenticate request may be sent from the NSWOF (742) to the AUSF.

At step S734, the Nausf_AUAuthentication_Authenticate response may be sent from the AUSF to the NSWOF (742).

At step S735, the SWA Protocol message may be sent from the NSWOF (742) to the NRF entity.

At step S736, the EAP success message may be sent from the WLAN (741) to the UE. The WLAN keys may be derived from a Pairwise Master Key (PMK).

At step S737, the UE may establishe security (4-way handshake) with the WLAN (741).

At step S738, the UE may share the local IP configuration with the WLAN.

FIG. 8 is a block diagram that illustrates the ABE system creating and distributing the secret keys to Third Party Service Providers (3SP), according to the embodiment disclosed herein.

A Certificate Authority (CA) block (801) issues X.509 certificates (805) to users (EE). The CA further maintains Certificate Revocation Lists (CRLs).

An ABE Authority block (803) sets up the ABE system by creating and distributing the secret keys to Third Party Service Providers (3SP).

A Key Transport block (807) transports the key from the ABE Authority (803) to the ABE 3SP (811).

An ABE Platform Provider (PP) block (809) provides the ABE platform for the ABE 3SP.

The ABE Third Party Service Provider (3SP) block (811) provides ABE services to end clients.

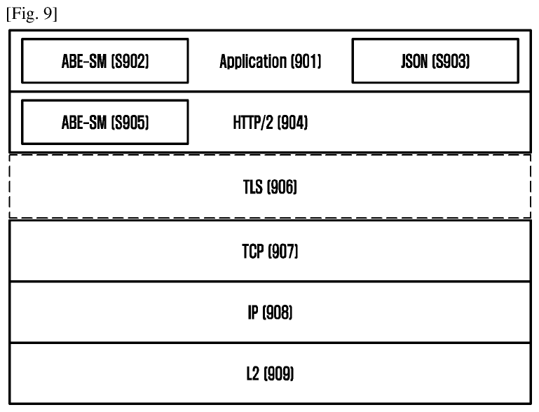

FIG. 9 is a schematic diagram that illustrates encryption/decryption of the contents in service operation messages that can be performed at the HTTP/2 or HTTP/3 layer, according to the embodiments as disclosed herein. FIG. 6 illustrates the encryption/decryption of the contents in service operation messages that can be performed at the HTTP layer (HTTP/2 or HTTP/3) or at the Application (for example, JSON) layer by the CP-ABE security module (ABE-SM). If the CP-ABE encryption/decryption is applied at the HTTP layer between the NF producer entity and the NF consumer entity, then the CP-ABE security material (MPK and/or SK_S and the encryption/decryption security algorithms) required for the encryption/decryption of the service operation messages are available/in possession/configured at the HTTP layer. The HTTP layer performs the encryption/decryption. In other words, ABE-SM is at the HTTP layer.

In an embodiment, if encryption/decryption is performed by JavaScript Object Notation (JSON) at the application layer, then the JSON Web Encryption (JWE) uses the CP-ABE security material (MPK and/or SK_S and the encryption/decryption security algorithms) for encryption/decryption of the service operation messages. In this case, ABE-SM is either co-located with the JSON or JSON obtain the security materials from the ABE-SM in the application layer.

In an embodiment, the FIG. 6 illustrates the CP-ABE encryption/decryption algorithms being, TKN20. The NF producer entity generates a Traffic Protection Key (TPK) and encrypts it using ciphertext-policy attribute-based encryption (CP-ABE).

Then the NF producer entity distributes or shares the encrypted TPK to the NF consumer entity.

In an embodiment, the TPK is used for traffic (service operation messages) protection (encryption and/or integrity protection) between the NF consumer entity and the NF producer entity. Symmetric cryptographic algorithms (for encryption/decryption and/or Integrity protection) with TPK is used for traffic protection between the NF consumer entity and the NF producer entity.

In another embodiment, the TPK is considered as Master session key and further keys (session keys) are derived from the TPK. In an illustrative example, the TPK is used to drive the sessions or as session key for Transport Layer Security (TLS) protocol or Quick UDP Internet Connections (QUIC) protocol or Datagram Transport Layer Security (DTLS) protocol.

In an embodiment, the TPK is considered as Pre-Shared Key (PSK) for TLS authentication.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method performed by a network repository function (NRF) entity for supporting a ciphertext policy attribute based encryption (CP-ABE) in 5G core (5GC) service based interface (SBI), the method comprising:
storing a network function (NF) service producer profile of a plurality of NF service producer entities and a NF service consumer profile of a plurality of NF service consumer entities;
generating a master public key and master secret key using a key management server;
transmitting the master public key to each NF service producer entity of the plurality of NF service producer entities;
receiving a secret key request message from the NF service consumer entity;
determining whether the NF service consumer entity is authorized based on an attribute criterion, wherein the attribute criteria comprises a set of attributes and their corresponding values;
generating a secret key based on the set of attributes with corresponding values and the master secret key, when the NF service consumer entity is authorized for the attribute criteria; and
transmitting a secret key response message comprising the secret key to the NF service consumer entity for the target NF service producer entity.

2. The method of claim 1, wherein storing the NF service consumer profile further comprising:
receiving a client registration request message from the NF service consumer entity;
sending a client registration response message to the NF service consumer entity; and
storing the NF service consumer profile of the NF service consumer entity, based on a successful registration of the NF service consumer entity.

3. The method of claim 1, wherein the set of attributes comprises at least one of a NF ID, a NF type, a service name, a type of operation, a slice ID, a PLMN ID, or a SNPN ID.

4. A method performed by a network function (NF) service producer entity for supporting a ciphertext policy attribute based encryption (CP-ABE) in 5G core (5GC) service based interface (SBI), the method comprising:
receiving a master public key from an NRF;
receiving a service access request message from a NF service consumer entity;
generating a service access response message;
encrypting the service access response message using an access policy and the master public key received from the NRF entity; and
transmitting the encrypted service access response message to the NF service consumer entity.

5. The method of claim 4, wherein the encrypted service access response message is sent in a NF service response message as a ciphertext over the access policy.

6. The method of claim 4, wherein the access policy comprises at least one of a generic access policy and a restricted access policy.

7. A method performed by a network function (NF) service consumer entity for supporting a ciphertext policy attribute based encryption (CP-ABE) in 5G core (5GC) service based interface (SBI), the method comprising:
sending a secret key request message to an network repository function (NRF) entity;
receiving a secret key response message comprising a secret key from the NRF entity, wherein the secret key response message comprises an attribute criterion based on which the secret key is generated by the NRF entity;
sending a service access request message to a NF service producer entity;
receiving an encrypted service access response message from the NF service producer entity, wherein the encrypted service access response message comprises an access policy based on which the encrypted service access response message is generated by the NF service producer entity; and
decrypting the encrypted service access response message using the secret key.

8. The method of claim 7, wherein decrypting the encrypted service access response message using the secret key further comprises:
decrypting, by the NF service consumer entity, the encrypted service access response message when the attribute criteria of the NF service consumer entity satisfy the access policy of the NF service producer entity.

9. A network repository function (NRF) entity for supporting a ciphertext policy attribute based encryption (CP-ABE) in 5G core (5GC) service based interface (SBI), the NRF entity comprising:
a transceiver; and
at least one processor configured to:
store a network function (NF) service producer profile of a plurality of NF service producer entities and a NF service consumer profile of a plurality of NF service consumer entities, generate a master public key and master secret key using a key management server,
transmit, via the transceiver, the master public key to each NF service producer entity of the plurality of NF service producer entities, receive a secret key request message from the NF service consumer entity,
determine whether the NF service consumer entity is authorized based on an attribute criterion, wherein the attribute criteria comprises a set of attributes and their corresponding values,
generate a secret key based on the set of attributes with corresponding values and the master secret key, when the NF service consumer entity is authorized for the attribute criteria, and
transmit a secret key response message comprising the secret key to the NF service consumer entity for the target NF service producer entity.

10. The NRF entity of claim 9, wherein the at least one processor is further configured to:
receive a client registration request message from the NF service consumer entity,
send a client registration response message to the NF service consumer entity, and
store the NF service consumer profile of the NF service consumer entity, based on a successful registration of the NF service consumer entity.

11. The NRF entity of claim 9, wherein the set of attributes comprises at least one of a NF ID, a NF type, a service name, a type of operation, a slice ID, a PLMN ID, or a SNPN ID.

12. A network function (NF) service producer entity for supporting a ciphertext policy attribute based encryption (CP-ABE) in 5G core (5GC) service based interface (SBI), the NF service producer entity comprising:
a transceiver; and
at least one processor configured to:
receive, via the transceiver, a master public key from an NRF,
receive a service access request message from a NF service consumer entity,
generate a service access response message,
encrypt the service access response message using an access policy and the master public key received from the NRF entity, and
transmit the encrypted service access response message to the NF service consumer entity.

13. The NF service producer entity of claim 12, wherein the encrypted service access response message is sent in a NF service response message as a ciphertext over the access policy.

14. The NF service producer entity of claim 12, wherein the access policy comprises at least one of a generic access policy and a restricted access policy.

15. A network function (NF) service consumer entity for supporting a ciphertext policy attribute based encryption (CP-ABE) in 5G core (5GC) service based interface (SBI), the NF service consumer entity comprising:
a transceiver; and
at least one processor configured to:
send, via the transceiver, a secret key request message to an network repository function (NRF) entity,
receive, via the transceiver, a secret key response message comprising a secret key from the NRF entity, wherein the secret key response message comprises an attribute criterion based on which the secret key is generated by the NRF entity,
send a service access request message to a NF service producer entity, receive an encrypted service access response message from the NF service producer entity, wherein the encrypted service access response message comprises an access policy based on which the encrypted service access response message is generated by the NF service producer entity, and
decrypt the encrypted service access response message using the secret key.
